(19) United States
(12) Patent Application Publication
(10) Pub. No.: US 2006/0137853 A1
(43) Pub. Date: Jun. 29, 2006

(54) Ventilation/heating and/or air conditioning device for the passenger compartment of a motor vehicle with simultaneous cooling of air and coolant

(75) Inventors: Regine Haller, Boissy Sans A Voir (FR); Loic Lepetit, Clenay (FR)

Correspondence Address: Valeo Climate Control Corp;Intellectual Property Department, 4100 North Atlantic Boulevard, Auburn Hills, MI, 48326, US

(73) Assignee: VALEO CLIMATISATION, La Verriere (FR)

(21) Appl. No.: 10/543,956

(22) PCT Filed: Feb. 16, 2004
(86) PCT No.: PCT/FR04/00352

§ 371 Date: Aug. 1, 2005

(30) Foreign Application Priority Data
Feb. 20, 2003 (FR) 03/02072

(51) Int. Cl. B60H 3/00

(52) U.S. Cl. 165/42

(57) ABSTRACT

The invention relates to a ventilation, heating and/or air conditioning equipment for the passenger compartment of a motor vehicle provided with a main thermodynamic loop comprising at least, according to the direction of flow of a refrigerant fluid:
a compressor (14),
a condenser (16),
an expansion device (20), and
a main air-cooling evaporator (22). According to the invention, the equipment furthermore comprises a secondary fluid loop for the flow of a heat conductor fluid coupled with the main thermodynamic loop in order to cool the heat conductor fluid when this is desirable.

The invention relates to a ventilation, heating and/or air conditioning equipment for the passenger compartment of a motor vehicle with simultaneous cooling of air and of a heat conductor fluid.

At the present time, ventilation, heating and/or air conditioning equipments for the passenger compartment of a motor vehicle generally comprise a closed thermodynamic loop functioning according to the principle of the Evans-Perkins cycle. This loop comprises at least, according to the direction of flow of a refrigerant fluid, an air-cooling evaporator, a compressor, a condenser and an expansion valve. In this configuration, the air is cooled by passage over the evaporator before being expelled into the passenger compartment through ducts.

Now, when the vehicle is stopped, these equipments have poor performance or even do not function at all. This is particularly a nuisance in the case of great heat, particularly in summer when the vehicle is parked in the sunshine, this heat causing a heating up of the passenger compartment with surface temperatures (dashboard, door, steering wheel) that can reach 45° C., or even 60° C.

Moreover, in recent vehicles which are equipped with an engine management system called “Stop and Go”, that is to say the stopping of the internal combustion engine when the vehicle is static, for example at traffic lights or at a stop, and then restarting it when it is desired that the vehicle should move forward again, by means of a alternator/starter, the engine can no longer drive the compressor when the latter is mechanical. The air conditioning is therefore frequently interrupted, which acts against the general comfort of the passengers.

The purpose of the present invention is therefore to solve these problems by valorizing and optimizing the thermodynamic loop by the simultaneous cooling of air and of a heat conductor fluid in order to store frigories when the internal combustion engine is functioning and by retrieving said frigories when the engine is stopped.

More precisely, the invention relates to a ventilation, heating and/or air conditioning equipment for the passenger compartment of a motor vehicle provided with a main thermodynamic loop comprising at least, according to the direction of flow of a refrigerant fluid in closed circuit:
a compressor,
a condenser,
an expansion device, and
a main air-cooling evaporator for cooling the passenger compartment,

said equipment furthermore comprising a secondary fluid loop for the flow of a heat conductor fluid coupled with the main thermodynamic loop in order to cool the heat conductor fluid.

This solution applies particularly well when the engine is idling or when the vehicle is stopped.

Advantageously, the secondary fluid loop comprises at least one auxiliary evaporator which ensures the transfer of energy between the main thermodynamic loop (11) and the secondary fluid loop (12).

According to a preferred embodiment of the invention, the secondary fluid loop comprises, according to the direction of flow of the heat conductor fluid in closed circuit:

the auxiliary evaporator, traversed by the heat conductor fluid and by the refrigerant fluid of the main thermodynamic loop,

an electric pump, and

a device for storing frigories intended to be redistributed, when this is desirable, by a cold exchanger.

Preferably, the secondary fluid loop furthermore comprises an air-cooling cold exchanger disposed between the electric pump and the frigories storage device.

Preferably, a first solenoid valve is fitted at the output of the air-cooling cold exchanger and a second solenoid valve is fitted between the electric pump and the frigories storage device, in a branch circuit, in order to favor either the accumulation of frigories in the storage device, or the redistribution of the stored frigories by the passage of the heat conductor fluid through the air-cooling cold exchanger.

Advantageously, the auxiliary evaporator is directly connected to the main air-cooling evaporator by the intermediary of a heat pipe.

Preferentially, the frigories storage device contains a phase changing material which is swept by the heat conductor fluid in order to store and then to release frigories into the secondary fluid loop.

Preferably, the secondary fluid loop furthermore comprises an additional equipment to be cooled, said additional equipment to be cooled being inside the passenger compartment, such as a seat or a surface of the passenger compartment, and/or outside of the passenger compartment, such as an electric motor, a battery or any other appended electrical equipment.

According to another embodiment of the invention, the equipment furthermore comprising an air circulation ducting inside of which are placed, according to the direction of flow of the air, the cold exchanger, the main evaporator and a heating radiator belonging to a third heating fluid loop, the main evaporator occupies the whole cross-section of the duct such that the air is forced to pass through it in order to be cooled.

Preferably, obturating and air distribution flaps are placed in front of the cold exchanger and in front of the heating radiator in order to vary the temperature of the air expelled into the passenger compartment.

According to a variant embodiment, the main evaporator occupies only a part of the cross-section of the duct and obturating and air distribution flaps are placed in front of the cold exchanger, the main evaporator and the heating radiator in order to vary the temperature of the air expelled into the passenger compartment.

Preferably, the third heating fluid loop is provided with an obturating valve making it possible, as a function of the temperature existing inside the passenger compartment and of the temperature to be reached, to use the thermal inertia of the heating radiator when the heat engine is stopped.

Also preferably, the third heating fluid loop is equipped with a branch circuit comprising an electric pump and a reservoir for storing glycol water for interrupting the flow of the glycol water or releasing frigories to the heating radiator when the engine is stopped.

The invention also relates to a motor vehicle equipped with a ventilation, heating and/or air conditioning equipment for a passenger compartment such as defined above.

Other features, details and advantages of the invention will emerge on reading the description given with reference to the appended drawings, given by way of example and which respectively show:

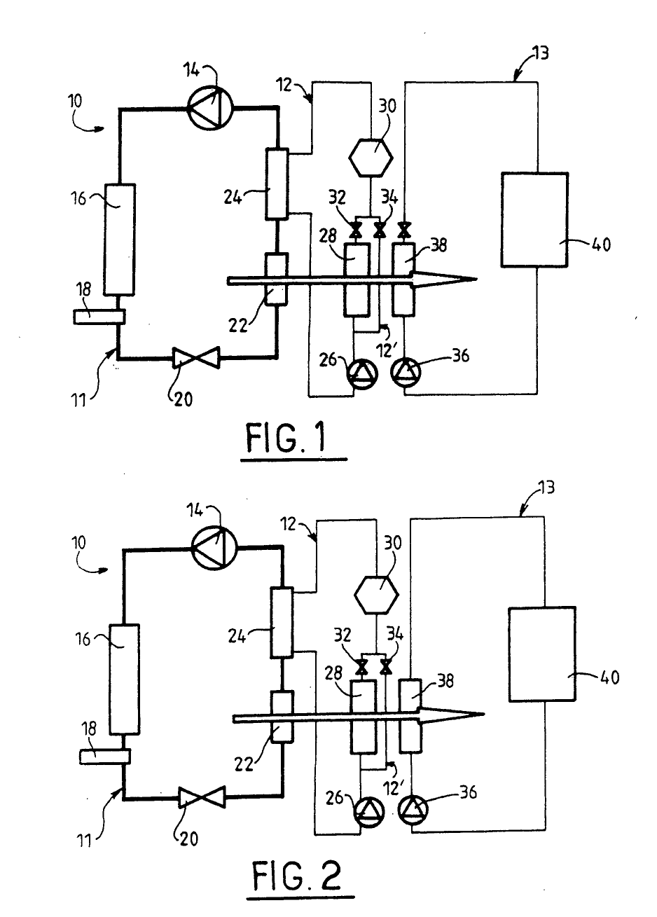

in FIG. 1, a schematic view of a first embodiment of a ventilation, heating and/or air conditioning equipment according to the present invention,

in FIG. 2, a schematic view of a first mode of operation of the ventilation, heating and/or air conditioning equipment shown in FIG. 1,

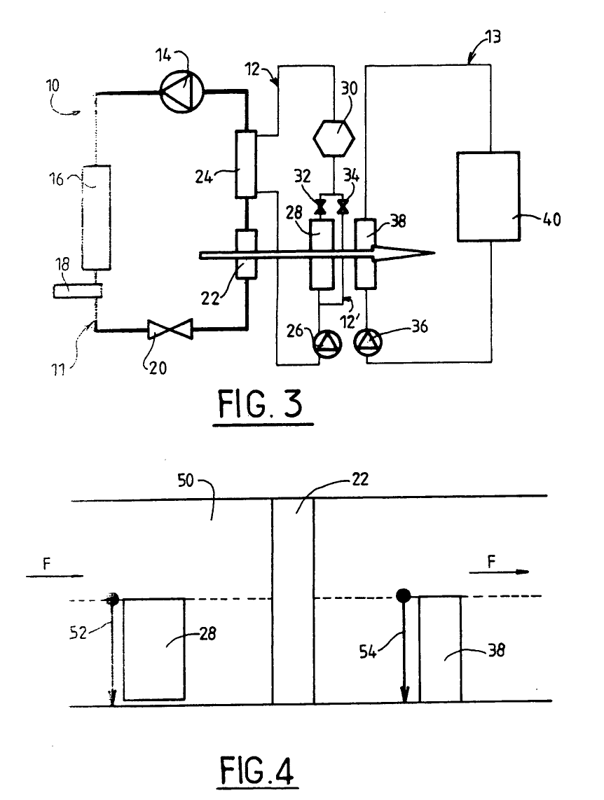

in FIG. 3, a schematic view of a second mode of operation of the ventilation, heating and/or air conditioning equipment shown in FIG. 2,

in FIG. 4, a detailed schematic view of an air flow duct of the ventilation, heating and/or air conditioning equipment shown in FIG. 1,

in FIG. 5, a detailed schematic view of a variant embodiment of FIG. 4,

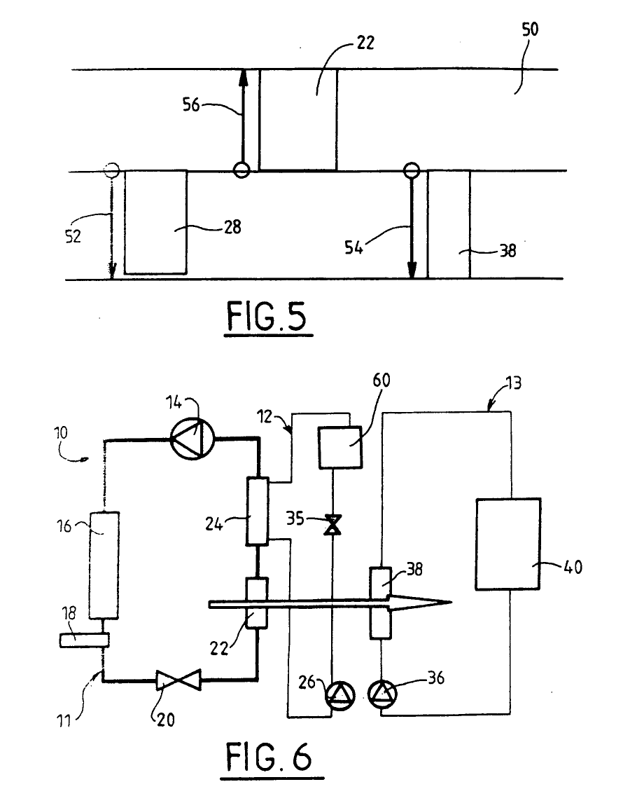

in FIG. 6, a schematic view of a second embodiment of a ventilation, heating and/or air conditioning equipment according to the present invention,

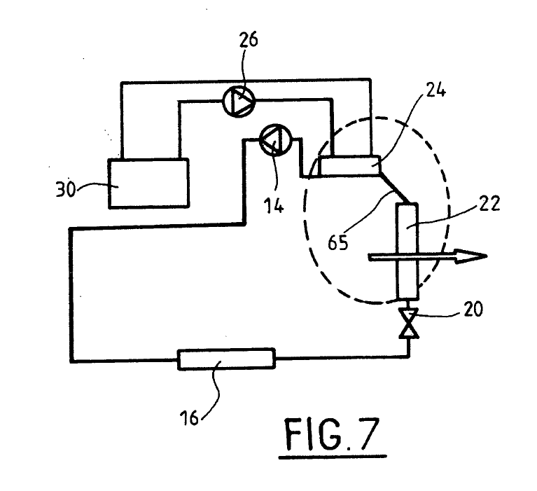

in FIG. 7, a schematic view of a third embodiment of a ventilation, heating and/or air conditioning equipment according to the present invention,

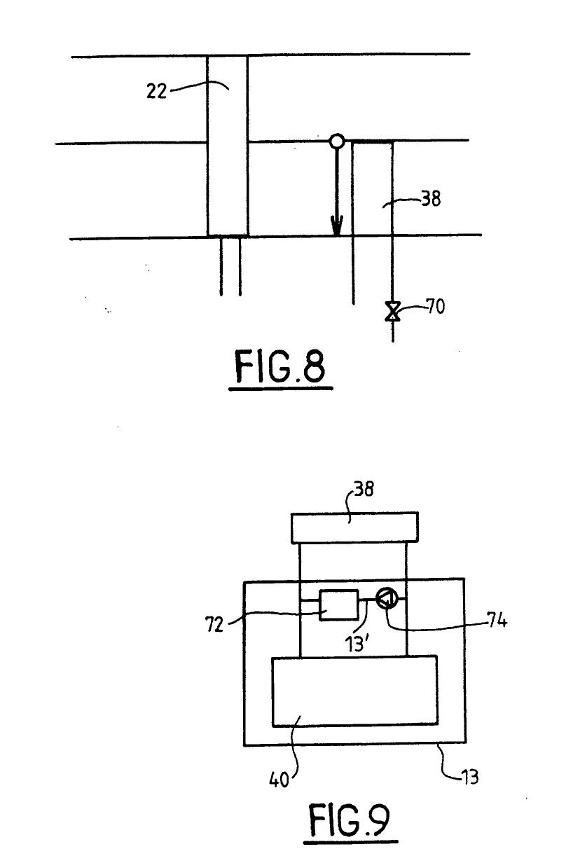

in FIG. 8, a schematic view of a fourth embodiment of a ventilation, heating and/or air conditioning equipment according to the present invention, and

in FIG. 9, another schematic view of the ventilation, heating and/or air conditioning equipment shown in FIG. 9.

FIG. 1 shows in a diagrammatic manner a ventilation, heating and air conditioning equipment 10 for the passenger compartment of a vehicle. This equipment 10 comprises a main thermodynamic loop 11, a secondary fluid loop 12 and a heating fluid loop 13 which are described in detail below.

The main thermodynamic loop 11 comprises, according to the direction of flow in closed circuit of a refrigerant fluid such as R134A: a compressor 14, a condenser 16, a storage bottle 18, an expansion valve 20 such as an electronic expansion valve, an air-cooling evaporator 22 and an auxiliary evaporator 24. The air-cooling evaporator 14, also called the main evaporator in the continuation of the description, is placed in an air flow duct 50 (shown in FIGS. 4 and 5) ending in different zones of the passenger compartment to be cooled or to be heated such as one for the demisting of the windshield, an aeration zone and zone for feet.

The auxiliary evaporator 24, of the plate type, is also part of the secondary fluid loop 12 which furthermore comprises, according to the direction of flow in closed circuit of a heat conducting fluid, such as glycol water, an electric pump 26, an air-cooling cold heat exchanger 28 (called a “cold radiator”) and a device 30 for storing frigories produced by said secondary fluid loop 12. This accumulator 30 can consist of a reservoir of heat conductor fluid which stores the frigories as perceptible heat, or it can contain phase changing material to work using latent heat in order to reduce the mass necessary and to limit the temperature variations of the storage. A first solenoid valve 32 is disposed at the output of the cold heat exchanger 28, and a second solenoid valve 34 is disposed between the electric pump 26 and the storage device 30, in a branch circuit 12′.

The heating fluid loop 13 comprises, according to the direction of flow in closed circuit of a heat conductor fluid such as glycol water, a mechanical pump 36, a heating radiator 38 and a heat engine 40 (or an intermediate cooling radiator of the latter). The heating radiator 38 is also placed in the same air flow duct 50 as that in which the air-cooling evaporator 22 is placed. This part of the invention is described in more detail with reference to FIGS. 4 and 5.

According to a first mode of operation of the equipment of the ventilation, heating and air conditioning equipment of the invention 10, such as shown in FIG. 2, called the frigories storage mode, the first solenoid valve 32 is in the closed position and the second solenoid valve 34 is in the open position such that the heat conductor fluid flows from the electric pump 26 to the storage device 30. The recycled air, or air coming from outside of the passenger compartment, then passes through the main evaporator 22 in order to be cooled in it, then it passes through the cold heat exchanger 28 without notable effect on the temperature of the air and, finally, it passes or does not pass through the heating radiator 38, as also shown in FIGS. 4 and 5.

According to a second mode of operation of the ventilation, heating and air conditioning equipment of the invention 10, such as shown in FIG. 3, called the mode of redistribution of frigories over the air circuit, the first solenoid valve 32 is in the open position and the second solenoid valve 34 is in the closed position such that the refrigerant fluid stored in the storage device 30 passes through the auxiliary plate evaporator 24 and then is pumped by the electric pump 26 in order to be sent to the cold heat exchanger 28. The recycled air, or air coming from outside of the passenger compartment, then passes through the main evaporator 22, then passes through the cold heat exchanger 28 in order to be cooled there, and finally passes or does not pass through the heating radiator 38 as is also shown in FIGS. 4 and 5.

Thus, according to the position of the solenoid valves 32 and 34, it is possible to favor either the storage of frigories in the accumulator 30, or the redistribution of the stored frigories to the auxiliary evaporator 24 by passing the heat conductor fluid through the air-cooling cold exchanger 28.

FIGS. 4 and 5 show two aeraulic diagrams for the distribution of the air. In the diagram of FIG. 4, the main air-cooling evaporator 22 occupies the whole of the cross-section of the airflow duct 50 with, according to the direction of flow of the air illustrated by the arrow F, the cold heat exchanger 28 placed upstream of the main evaporator 14, and the heating radiator 38 placed downstream of said evaporator 14, so that the air must pass through the main evaporator 22. Distribution flaps 52 and 54 make it possible to regulate the temperature of the air by making the air pass or not pass through the cold heat exchanger 28 and/or the heating radiator 38.

In the diagram of FIG. 5, the main evaporator 22 occupies only a part of the cross-section of the flow duct 50 and a third obturating flap 56 is placed upstream of said main evaporator 22 in order to cause the air to pass or not to pass through the latter. The disposition of the other two flaps 52 and 54, and of the heating radiator 38 and of the cold exchanger 28, remains identical to that of the similar items in FIG. 4.

Application of the System for Air Conditioning an Automobile While Stopped During “Stop and Go” Functioning:

After the rise in temperature phase (heating up of the passenger compartment of the vehicle to a high temperature), the surplus cooling capability provided by the main thermodynamic loop 11, by the intermediary of the evaporator 24, is valorized for cooling the heat conductor fluid which passes through the frigories storage device 30.

In the case of vehicles functioning in “Stop and Go”, the internal combustion engine 40 is stopped during the Stop phases and can no longer drive the compressor 36 when the latter is mechanical, as in present-day vehicles. During this critical phase, the secondary loop 12 operates in destocking mode. The heat conductor fluid is made to flow by the electric pump 26 and passes through the cold exchanger 28 interposed in the air flow. According to the capacity of the frigories accumulator 30, a surplus of cold air can thus be distributed during a limited time, of the order of a few tens of seconds. The time and the quality of the cooling are determined by:

the mass and the thermal characteristics of the accumulator 30 (calorific capacity, phase changing enthalpy, time constant, etc.)

the characteristics of the cold exchanger 28 (efficiency of the exchanger). The latter must have a good performance in order to obtain sufficiently cold air with a heat conductor fluid at a temperature which can vary between 0° C. and 15° C.

Optimization of the Energy Performance:

In phases of great need for cooling the air, the electric pump 26 does not operate and the solenoid valves 32 and 34 are closed. In this state, the main thermodynamic loop 11 functions with its nominal performance. The thermal inertia of the auxiliary evaporator 24 has a low impact insofar as the heat conductor fluid does not flow in the secondary fluid loop 12. During the initial moments, the effect of its inertia is compensated for by a better performance of the main evaporator 22 in the air flow because it is operating in flooded mode, that is to say saturated in the liquid phase.

In the phases during which the main thermodynamic loop 11 provides a surplus of cold to the air circuit, the electric pump 26 is then activated and the second solenoid valve 34 of the branch circuit 12′ of the cold exchanger 28 is open. The variable flow pump 26 thus makes it possible to take cold from the secondary loop 12 in a limited manner in order not to degrade the normal air cooling functioning. This operational mode makes it possible to regulate the temperature blown into the passenger compartment without reheating air over the hot radiator 38 after its cooling over the evaporator 22 by the so-called “reheat” phenomenon, or this “reheat” us limited to the cases of control of humidity associated with a risk of fogging the windshield or having an effect on comfort. This functioning avoids the energy aberration which consists in reheating the cooled air. The stored frigories can then be re-injected in the air circuit by the intermediary of the cold exchanger 28 during stopped phases of the compressor 14.

Regulation:

For the storage applications (Stop and Go or energy optimization), different regulation parameters are envisaged. The regulation will be able to act upon:

The flow rate and the temperature of the heat conductor fluid, the air flow rate of the pulser, the distribution of the air flow using flaps, with a possible variant making it possible to do without the main evaporator 22 completely or partially.

The cubic capacity of the compressor 14 or its starting. The demand for cold in the passenger compartment has priority in this case. When the refrigeration capability of the main loop 11 is excessive in comparison with this need, the storage mode is initiated.

The power taken from the auxiliary evaporator 24 is adjusted as required, by adaptation of the air flow rate to what is just necessary or by the partial bypass of the auxiliary evaporator 24, when this is provided. In fact, in order to store frigories efficiently, it is appropriate to maintain the low pressure at a sufficiently low level. This would lead to a power in the blown air that is too great and to a necessity to “reheat”, which is a waste of energy.

Another method of regulation in this configuration could be the partial use of the auxiliary evaporator 24, for example by masking a zone of the latter.

In the case of seeking optimum energy performance, it is imperative to be able to regulate the rate of air flow passing through the main air-cooling evaporator 22. Preferably, this variation of the flow rate through the main evaporator 22 is carried out by retaining the global air flow rate but by partially bypassing said evaporator in order to avoid variations in air speeds felt by the passengers.

FIG. 6 shows a second embodiment of the invention. According to this second embodiment, the secondary fluid loop 12 comprises the auxiliary plate evaporator 24, the electric pump 26, a solenoid valve 35 and an equipment 60 to be cooled, either outside of the passenger compartment, such as an electric motor, a battery or a drive transmission system or an appended electrical equipment such as the control electronics, or inside the passenger compartment, such as a seat or a surface (dashboard, roof, doors, etc). The objective is to ensure better comfort for the passengers or to ensure the thermal conditioning of equipments sensitive to temperature (electric motor, batteries) by using the cooled heat conductor fluid. The circuits of the heat conductor fluid can easily be adapted according to the requirement. In this case of utilization, the installation of a thermal accumulator is not essential. However, an intermediate storage can be advantageous for optimizing the energy system. The priority of cooling between the air of the passenger compartment and the equipments is managed by the regulation according to the strongest constraints.

FIG. 7 shows a third embodiment of the invention. The objective is again to ensure the comfort of the passengers during phases when the engine is stopped. It is a matter of storing frigories when the internal combustion engine is functioning and of retrieving them in the passenger compartment when the engine is stopped. The production of cold is ensured by the main thermodynamic loop 11. A simultaneous production of cold air and of cold heat conductor fluid, such as cold glycol water, makes it possible to store frigories in a specific exchanger. The distribution of the stored energy is thus carried out using a heat pipe 65 interposed directly between the main evaporator and the auxiliary plate evaporator. The advantage of this method of distribution is to limit the modifications to be applied to the ventilation, heating and air conditioning equipment 10 in order to provide this new function. Power is therefore transferred between the two evaporators by the heat pipe effect. This functioning assumes that the glycol water is put into circulation by an electric pump to ensure the transfer of frigories between the storage zone and the plate evaporator.

Two main operation modes are identified:

During the phases when the internal combustion engine 40 is functioning and driving the compressor, the main thermodynamic loop 11 produces cold. The pump 26 of the secondary fluid loop 12 functions during the storage modes.

During the phases when the internal combustion engine 40 is stopped, the maintaining of comfort can be provided for about 30 s by distributing the stored frigories. The time of maintaining comfort is directly related to the storage capacity. For 30 s, it is necessary to provide 250 g of ice, 500 g of phase changing material of the Rubitherm type or approximately 2 kg of glycol water. In this functioning phase, the zone of the refrigerant circuit containing the two evaporators 22 and 24 is isolated from the rest of the circuit by the compressor on the one hand and by the expansion valve on the other hand. These components will be chosen according to this constraint.

The heat pipe effect ensures the direct transfer of liquid between the auxiliary plate evaporator 24, in which condensation will take place, and the main evaporator 22. The correct functioning of this system requires that the auxiliary plate evaporator 24 is positioned at a higher altitude that that of the main evaporator 22. The circulation of the liquid phase in the heat pipe 65 may take place by gravity, subject to there being a sufficient difference in altitude between the two exchangers. The return of the gaseous phase is imposed by the pressure difference created between the condensation zone and the evaporation zone. Another solution is to provide the liquid transfer by capillarity if the walls of the circuit are designed to provide this function.

Maintaining comfort based on thermal inertia during phases when the internal combustion engine is stopped necessitates a certain storage mass. The required mass is evaluated on the basis of the stoppage times encountered in the standard cycles (European, American and Japanese). A duration of 30 s covers the majority of situations. The maximum power necessary to maintain comfort with a temperature of 45° C., a relative humidity of 40% and a solar flux of 1000 W/m² is evaluated at 2500 W in the recycling air setting in a middle-range vehicle. In order to maintain the power of 2500 W for 30 s, the thermal inertia necessary is 75000 J. This inertia corresponds to 227 g of ice, 500 g of phase changing material (fusion enthalpy of 150 kJ/kg), or 2.2 kg of glycol water whose temperature varies by 10° C.

A standard heating radiator weighs about 1 kg and contains approximately 0.3 kg of glycol water. Its thermal inertia is therefore 1000 J/kg/° C. This value makes it possible to maintain thermal comfort for only a few seconds. It is therefore necessary to adapt this inertia according to the sought duration of maintaining comfort. Despite everything, the advantage of using the radiator in terms of inertia is related to the fact that two functions can be provided in a single zone of small overall dimensions. The mass of the radiator is thus modified in order to increase the inertia, but the overall dimensions will be little affected, An additional mass of 1.5 kg can be integrated in the equivalent of a plate of dimensions 0.2 m×0.3 m×0.025 m.

The diagrams given in FIGS. 8 and 9 represent the flows of the different fluids in the ventilation, heating and air conditioning equipment 10. In order to valorize the zone of the heating radiator 38 in order to store frigories making it possible to ensure comfort for the passengers during the phases when the internal combustion engine is stopped for a duration of about 30 s, the adaptations to be considered are:

Provision of a controlled valve 70 in the glycol water circuit feeding the heating radiator 38,

Modifying the capacity of the radiator in terms of glycol water in order to increase its thermal inertia without notable increase in its general overall dimensions, as described above,

Managing the position of the flap placed in front of the radiator in order that air sweeps or does not sweep the radiator. In intermediate seasons (Temperature<20° C.), the heating radiator 38 is not valorized for storing frigories. The air conditioning will function normally in order to provide the demisting function. In hot seasons (Temperature>20° C. and strong sunshine), the valve 70 situated in the glycol water circuit is shut. The flap is then open to allow air to sweep the radiator zone.

The advantage of this solution is to be able to increase the thermal inertia without modifying the components integrated in the ventilation, heating and air conditioning equipment.

In FIG. 9, an additional storage reservoir 72 and an electric pump 74 are provided on a branch circuit 13′ of the engine cooling loop 13. The control of the flow rate of glycol water in this loop is carried out as a function of the temperatures and of the functioning of the internal combustion engine. The storage reservoir 72 can contain a phase changing material in order to increase the thermal inertia/mass ratio and to allow stability of the storage temperature.

It must however be well understood that these examples are given solely by way of illustration of the subject of the invention of which they in no way constitute a limitation.

Thus, the bottle and the electronic expansion valve of FIGS. 1 to 3 can be replaced either by a bottle and a calibrated orifice, or by an accumulator upstream of the compressor 14 and a thermostatic valve.

1. A ventilation, heating and/or air conditioning equipment for the passenger compartment of a motor vehicle provided with a main thermodynamic loop (11) comprising at least, according to the direction of flow of a refrigerant fluid in closed circuit:
a compressor (14),
a condenser (16),
an expansion device (20),
a main air-cooling evaporator (22) for cooling the passenger compartment,
characterized in that it furthermore comprises a secondary fluid loop (12) for the flow of a heat conductor fluid coupled with the main thermodynamic loop (11) in order to cool the heat conductor fluid.

2. The equipment as claimed in claim 1, in which the secondary fluid loop (12) comprises at least one auxiliary evaporator (24) which ensures the transfer of energy between the main thermodynamic loop (11) and the secondary fluid loop (12).

3. The equipment as claimed in claim 2, in which the secondary fluid loop (12) comprises, according to the direction of flow of the heat conductor fluid in closed circuit:
the auxiliary evaporator (24), traversed by the heat conductor fluid and by the refrigerant fluid of the main thermodynamic loop (11),
an electric pump (26), and
a device (30) for storing frigories intended to be redistributed, when this is desirable, by a cold exchanger (28).

4. The equipment as claimed in claim 3, in which the secondary fluid loop (12) furthermore comprises an air-cooling cold exchanger (28) disposed between the electric pump (26) and the frigories storage device (30).

5. The equipment as claimed in claim 4, in which a first solenoid valve (32) is fitted at the output of the air-cooling cold exchanger (28) and a second solenoid valve (34) is fitted between the electric pump (26) and the frigories storage device (30), in a branch circuit (12′), in order to favor either the accumulation of frigories in the storage device (30), or the redistribution of the stored frigories by the passage of the heat conductor fluid through the air-cooling cold exchanger (28).

6. The equipment as claimed in any one of claims 3 to 5, in which the auxiliary evaporator (24) is directly connected to the main air-cooling evaporator (22) by the intermediary of a heat pipe (65).

7. The equipment as claimed in any one of claims 3 to 6, in which the frigories storage device (30) contains a phase changing material which is swept by the heat conductor fluid in order to store and then to release frigories into the secondary fluid loop (12).

8. The equipment as claimed in any one of the preceding claims, in which the secondary fluid loop (12) furthermore comprises an additional equipment (60) to be cooled.

9. The equipment as claimed in claim 8, in which the additional equipment to be cooled (60) is inside the passenger compartment, such as a seat or a surface of the passenger compartment, and/or outside of the passenger compartment, such as an electric motor, a battery or any other appended electrical equipment.

10. The equipment as claimed in any one of claims 4 to 9, furthermore comprising an air circulation ducting (50) inside of which are placed, according to the direction of flow of the air (F), the cold exchanger (28), the main evaporator (22) and a heating radiator (38) belonging to a third hot fluid loop (13), characterized in that the main evaporator (22) occupies the whole cross-section of the duct (50) such that the air is forced to pass through it in order to be cooled.

11. The equipment as claimed in claim 10, in which obturating and air distribution flaps (52, 54) are placed in front of the cold exchanger (28) and in front of the heating radiator (38) in order to vary the temperature of the air expelled into the passenger compartment.

12. The equipment as claimed in any one of claims 4 to 9, furthermore comprising an air circulation ducting (50) inside of which are placed, according to the direction of flow of the air (F), the cold exchanger (28), the main evaporator (22) and a heating radiator (38) belonging to a third heating fluid loop (13), characterized in that the main evaporator (22) occupies only a part of the cross-section of the duct (50) and obturating and air distribution flaps (52, 54, 56) are placed in front of the cold exchanger (28), in front of the main evaporator (22) and in front of the heating radiator (38) respectively in order to vary the temperature of the air expelled into the passenger compartment.

13. The equipment as claimed in any one of claims 10 to 12, in which the third heating fluid loop (13) is provided with an obturating valve (70) making it possible, as a function of the temperature existing inside the passenger compartment and of the temperature to be reached, to use the thermal inertia of the heating radiator (38) when the heat engine is stopped.

14. The equipment as claimed in claim 13, in which the third heating fluid loop (13) is equipped with a branch circuit (13′) comprising an electric pump (74) and a reservoir (72) for storing glycol water for interrupting the flow of the glycol water or releasing frigories to the heating radiator (38) when the engine is stopped.

15. A motor vehicle equipped with a ventilation, heating and/or air conditioning equipment as claimed in any one of the preceding claims.
